(19) United States
(12) Patent Application Publication
(10) Pub. No.: US 2025/0006993 A1
(43) Pub. Date: Jan. 2, 2025

(54) BATTERY AND ELECTRONIC DEVICE

(71) Applicant: ZHUHAI COSMX BATTERY CO., LTD., Zhuhai (CN)

(72) Inventors: Hai WANG, Zhuhai (CN); Feng WANG, Zhuhai (CN); Suli LI, Zhuhai (CN); Junyi LI, Zhuhai (CN)

(73) Assignee: ZHUHAI COSMX BATTERY CO., LTD., Zhuhai (CN)

(21) Appl. No.: 18/830,869

(22) Filed: Sep. 11, 2024

Related U.S. Application Data
(63) Continuation-in-part of application No. PCT/CN2023/082130, filed on Mar. 17, 2023.

(30) Foreign Application Priority Data
Mar. 21, 2022 (CN) 202210276733.2

(51) Int. Cl. H01M 10/0567; H01M 10/04; H01M 10/0525; H01M 50/122; H01M 50/186

(52) U.S. Cl. CPC H01M 10/0567; H01M 10/0431; H01M 10/0525; H01M 50/122; H01M 50/186

(57) ABSTRACT

Disclosed are a battery and an electronic device. The battery includes a jelly roll, an electrolyte solution, and an aluminum-plastic film. The aluminum-plastic film includes an upper film and a lower film disposed opposite to each other, the upper film and the lower film cooperate to form an accommodating cavity, the jelly roll and the electrolyte solution are disposed in the accommodating cavity, a sealing edge is formed at a position at which the upper film and the lower film are connected, the sealing edge is configured to seal the accommodating cavity, the electrolyte solution includes a first additive, and the first additive includes a compound containing an —O—SO₂— group. In this way, the performance of the battery may be improved.

### CROSS-REFERENCE TO RELATED APPLICATIONS

The present disclosure is a continuation-in-part of International Application No. PCT/CN2023/082130, filed on Mar. 17, 2023, which claims priority to Chinese Patent Application No. 202210276733.2, filed on Mar. 21, 2022. Both of the aforementioned applications are hereby incorporated by reference in their entireties.

### TECHNICAL FIELD

The present disclosure relates to the field of battery technologies, and in particular, to a battery and an electronic device.

### BACKGROUND

Pouch lithium batteries have excellent energy density and cycling performance and have been widely used. However, when sealing performance of a battery is poor, water vapor can easily penetrate into the battery, to generate hydrogen fluoride that affects performance of the battery. In addition, a content of an electrolyte solution is usually configured based on experience in the prior art, which can easily lead to problems such as too much or too little additives in the electrolyte solution, and then cause problems such as battery expansion and performance degradation.

It may be learned that the battery in the prior art has the problem of poor performance.

### SUMMARY

Embodiments of the present disclosure provide a battery and an electronic device to solve a problem of poor battery performance in the art.

An embodiment of the present disclosure provides a battery. The battery includes a jelly roll, an electrolyte solution, and an aluminum-plastic film, where the aluminum-plastic film includes an upper film and a lower film disposed opposite to each other, the upper film and the lower film cooperate to form an accommodating cavity, the jelly roll and the electrolyte solution are disposed in the accommodating cavity, a sealing edge is formed at a position at which the upper film and the lower film are connected, the sealing edge is configured to seal the accommodating cavity, the electrolyte solution includes a first additive, and the first additive includes a compound containing an —O—SO₂— group.

In the embodiments of the present disclosure, the first additive is added to the electrolyte solution, so that the —O—SO₂— group in the first additive can form a solid electrolyte interface film on a surface of an electrode active material. The solid electrolyte interface film can reduce side reactions between the electrolyte solution and the electrode active material, thereby improving performance of the battery.

### BRIEF DESCRIPTION OF THE DRAWINGS

To describe technical solutions of embodiments of the present disclosure more clearly, the following briefly describes the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a schematic diagram 1 of a structure of a battery according to an embodiment of the present disclosure.

FIG. 2 is a schematic diagram 2 of a structure of a battery according to an embodiment of the present disclosure.

FIG. 3 is a schematic diagram 3 of a structure of a battery according to an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts fall within the protection scope of the present disclosure.

The terms “first”, “second”, and the like in the description and claims of the present disclosure are used to distinguish between similar objects but not to describe a particular sequence or order. It should be understood that the structures used in this way are interchangeable under appropriate circumstances so that the embodiments of the present disclosure can be implemented in a sequence other than those illustrated or described herein, and the objects distinguished by “first”, “second”, and the like are generally of the same type, and does not limit a quantity of objects. For example, a first object may be one first object, or may be a plurality of first objects. In addition, “and/or” in the specification and claims represents at least one of the connected objects, and the character “/” generally indicates an “or” relationship between the associated objects.

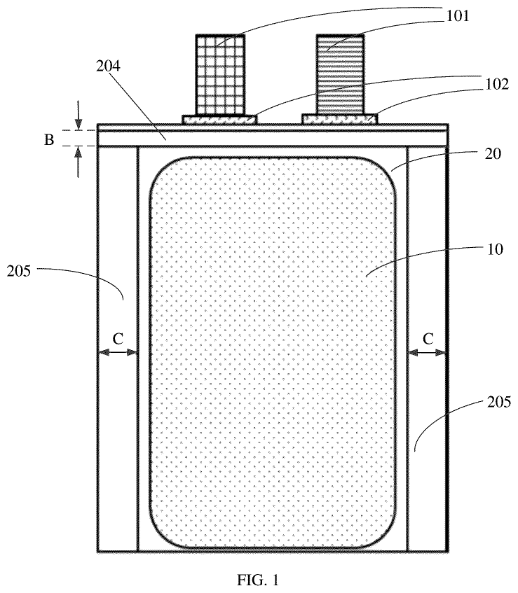

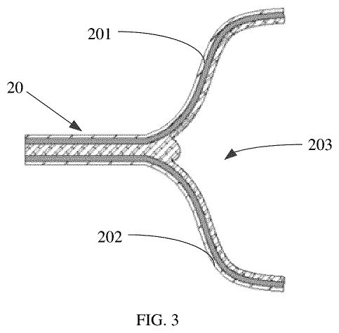

An embodiment of the present disclosure provides a battery. As shown in FIG. 1 to FIG. 3, the battery includes a jelly roll 10, an electrolyte solution, and an aluminum-plastic film 20, where the aluminum-plastic film 20 includes an upper film 201 and a lower film 202 disposed opposite to each other, the upper film 201 and the lower film 202 cooperate to form an accommodating cavity 203, the jelly roll 10 and the electrolyte solution are disposed in the accommodating cavity 203, a sealing edge is formed at a position at which the upper film 201 and the lower film 202 are connected, the sealing edge is configured to seal the accommodating cavity 203, the electrolyte solution includes a first additive, and the first additive includes a compound containing an —O—SO₂— group.

In this embodiment, the first additive is added to the electrolyte solution, so that the —O—SO₂— group in the first additive can form a solid electrolyte interface film on a surface of an electrode active material. The solid electrolyte interface film can reduce side reactions between the electrolyte solution and the electrode active material, thereby improving performance of the battery.

Herein, a structural formula of the —O—SO₂— group may be represented by Formula (1)

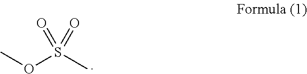

Optionally, the first additive may include at least one of compounds represented by Formula (I) to Formula (XXIV):

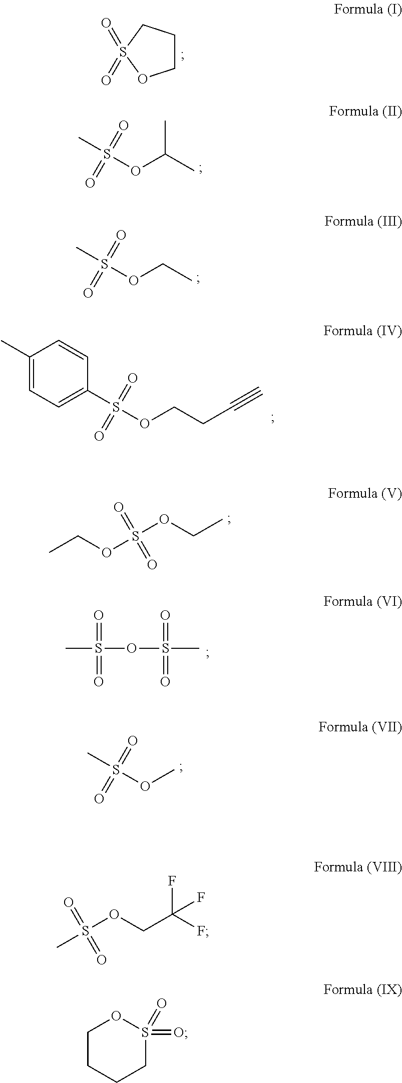

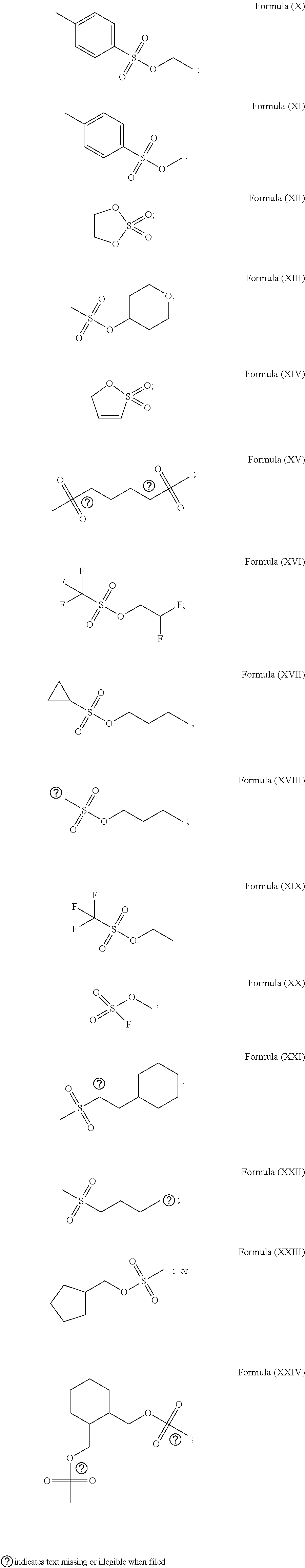

Optionally, the first additive includes at least one of compounds represented by Formula (I) to Formula (VIII):

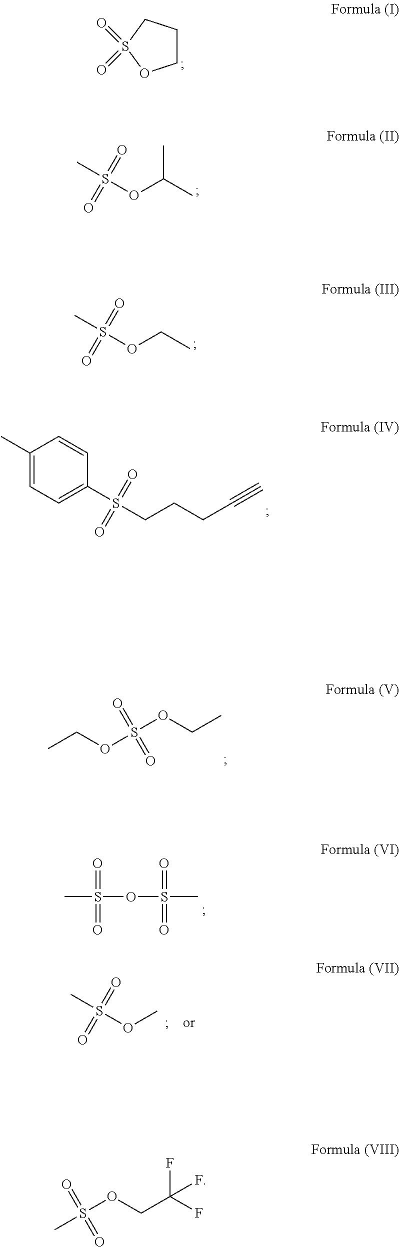

The —O—SO₂— group in the first additive can form a solid electrolyte interface film on a surface of an electrode active material, thereby reducing side reactions between the electrolyte solution and the electrode active material, and improving performance of the battery.

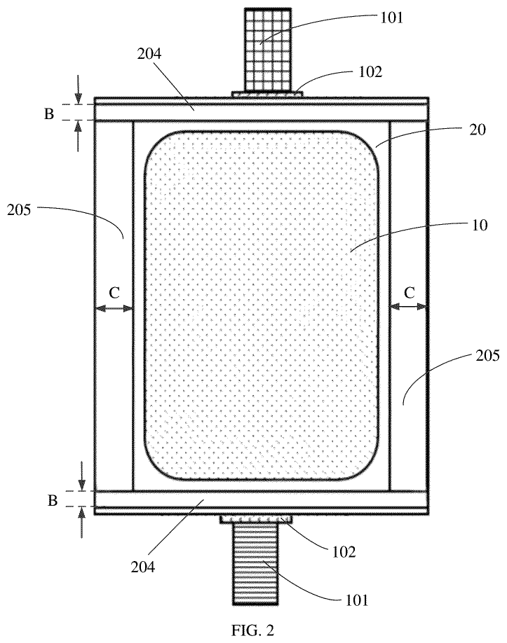

The jelly roll 10 and the electrolyte solution are disposed in the accommodating cavity 203, and the sealing edge is formed at the position at which the upper film 201 and the lower film 202 are connected. A schematic diagram of a structure of the battery obtained after packaging is shown in FIG. 1 or FIG. 2.

Optionally, the sealing edge may include a top sealing edge 204 and a side sealing edge 205, and a width B of the top sealing edge 204, a width C of the side sealing edge 205, and a content H of the first additive meet Formula 1 below:

$$Min ( B , C ) - 100 \times {H}^{2} \geq - 0.2 . \qquad ( Formula 1 )$$

Herein, the width of the top sealing edge 204 may be B, in a unit of mm, the width of the side sealing edge 205 may be C, in a unit of mm, the content of the first additive may be H, that is, a percentage of the first additive in a total mass of the electrolyte solution, and H≤10%.

In a relational expression of the present disclosure, only a numerical portion of each parameter rather than a unit portion participates in calculation. The foregoing relational expression is used as an example. In Example 1-1 of the present disclosure, the width B of the top sealing edge is 1 mm, the width C of the side sealing edge is 10 mm, and the content H of the first additive is 4%, then Min(B,C)−100×H²=1−100×0.04²=0.84.

When the first additive is contained in the electrolyte solution with an excessive content, the —O—SO₂— group easily reacts with water to generate sulfuric acid that has a great damage capability to the aluminum-plastic film 20, resulting in battery swelling and other problems. When the first additive is contained in the electrolyte solution with too little content, side reactions can still occur between the electrolyte solution and the electrode active material, reducing battery performance. When the width B of the top sealing edge 204, the width C of the side sealing edge 205, and the content H of the first additive meet a specific relationship, the sulfuric acid generated by the —O—SO₂— group in the first additive and water has lower corrosiveness to the aluminum-plastic film, and this lower corrosiveness is also beneficial to enhancing a packaging strength, thereby increasing a cycle life and a storage life of the battery.

In this implementation, the relationship between the width B of the top sealing edge 204, the width C of the side sealing edge 205, and the content H of the first additive is established, so that the cycle life and the storage life of the battery can be balanced, thereby improving performance of the battery.

The jelly roll 10 includes a positive electrode plate, a negative electrode plate, and a separator.

For preparation of the positive electrode plate, reference may be made to the following description:

The positive electrode plate includes a positive electrode active material LiNi_{0.5}Co_{0.2}Mn_{0.3}O₂, a binder polyvinylidene fluoride (PVDF), and a conductive agent acetylene black. LiNi_{0.5}Co_{0.2}Mn_{0.3}O₂, PVDF, and acetylene black could be mixed at a weight ratio of 97:1.5:1.5, and then N-methylpyrrolidone (NMP) was added. A resulting mixture was stirred under action of a vacuum mixer to form a positive electrode slurry. The positive electrode slurry could be evenly applied on an aluminum foil having a thickness of 12 micrometers. The coated aluminum foil was baked in a five-stage oven with different temperatures and then dried in an oven at 120° C. for 8 hours, followed by rolling and cutting, to obtain the required positive electrode plate.

For preparation of the negative electrode plate, reference may be made to the following description:

The negative electrode plate includes a negative electrode active material artificial graphite, a thickener sodium carboxymethyl cellulose (CMC—Na), a binder styrene-butadiene rubber, and a conductive agent acetylene black. The artificial graphite, sodium carboxymethyl cellulose, styrene-butadiene rubber, and acetylene black could be mixed at a weight ratio of 97:1:1:1. Then, deionized water was added. A resulting mixture was stirred under action of a vacuum mixer to form a negative electrode slurry. The negative electrode slurry could be evenly applied on a copper foil having a thickness of 8 micrometers. The coated copper foil was dried at room temperature, and then transferred to an oven at 80° C. for drying for 10 hours, followed by cold pressing and cutting, to obtain the required negative electrode plate.

For preparation of the electrolyte solution, reference may be made to the following description:

In a glove box filled with argon gas and with qualified water and oxygen contents (water content<1 ppm, oxygen content<1 ppm), ethylene carbonate, ethyl methyl carbonate, and diethyl carbonate were evenly mixed at a mass ratio of 30:50:20 to form a mixed solvent, and then 1 mole of lithium hexafluorophosphate was added to the mixed solvent. The mixture was stirred until the lithium hexafluorophosphate is completely dissolved. In addition, the first additive was added to the electrolyte solution, and the required electrolyte solution was obtained after passing water content and free acid tests.

The separator could be prepared with polyethylene having a thickness of 8 micrometers.

The positive electrode plate, the separator, and the negative electrode plate were sequentially stacked to ensure that the separator was located between the positive electrode plate and the negative electrode plate for separation, and then winding was performed to obtain a bare cell without electrolyte injection, that is, the jelly roll. The bare cell was placed in outer packaging foil, that is, the aluminum-plastic film, the prepared electrolyte solution was injected into the dried bare cell, and after processes such as vacuum packaging, standing, formation, shaping, and sorting, the required pouch lithium-ion battery was obtained.

In this implementation, Example 1, Examples 1-1 to 1-6, and Comparative Example 1 can be provided. In the comparative example and the examples, the width B of the top sealing edge 204, the width C of the side sealing edge 205, and the content H of the first additive are specifically shown in Table 1.

TABLE 1

| | First additive | | B | C | Min(B, C) |
|---|---|---|---|---|---|
| Sequence number | Type | H | (mm) | (mm) | 100 × H² |
| Example 1 | (I) | 8% | 0.3 | 10 | −0.34 |
| Example 1-1 | (II) | 4% | 1 | 10 | 0.84 |
| Example 1-2 | (III) | 4% | 4 | 10 | 3.84 |
| Example 1-3 | (IV) | 1% | 4 | 10 | 3.99 |
| Example 1-4 | (V) | 7% | 4 | 10 | 3.51 |
| Example 1-5 | (IX) | 4% | 4 | 10 | 3.84 |
| Example 1-6 | (X) | 4% | 4 | 10 | 3.84 |
| Comparative Example 1 | / | 0 | 4 | 10 | 4 |

Note:
“/” in Table 1 means nonexistence.

Performance tests were separately performed on the examples and the comparative example. The batteries obtained in the examples and the comparative example were charged and discharged five times at a charge-discharge rate of 1 C at room temperature, and then charged to 4.2 V at a rate of 1 C (with a cut-off current of 0.02 C). A 1 C capacity Q and a battery thickness T were recorded. After the fully charged battery was stored at 60° C. for 30 days, a battery thickness T0 and a 1 C discharge capacity Q1 were recorded. The battery was then charged and discharged at a rate of 1 C at room temperature for five cycles, and a 1 C discharge capacity Q2 was recorded. Experimental data such as a capacity retention rate, a capacity recovery rate, and a thickness expansion rate of the battery stored at a high temperature (60° C.) were obtained through calculation.

The record results are shown in Table 2.

TABLE 2

| | Storage at 60° C. | | |
|---|---|---|---|
| | Thickness | Capacity | Capacity |
| | expansion | retention | recovery |
| Sequence number | rate | rate | rate |
| Example 1 | 28.38% | 35.64% | 41.51% |
| Example 1-1 | 19.36% | 54.37% | 60.64% |
| Example 1-2 | 13.58% | 66.47% | 70.42% |
| Example 1-3 | 12.46% | 65.84% | 71.36% |
| Example 1-4 | 13.32% | 64.58% | 70.36% |
| Example 1-5 | 20.17% | 53.35% | 61.11% |
| Example 1-6 | 18.63% | 54.99% | 62.31% |
| Comparative | 40.35% | 25.44% | 34.88% |
| Example 1 | | | |

Capacity retention rate (%)=Q1/Q×100%. Capacity recovery rate (%)=Q2/Q×100%. Thickness expansion rate (%)=(T0-T)/T×100%.

It may be learned from Table 1 and Table 2 that Comparative Example 1 does not include the first additive, and has high-temperature storage performance poorer than that of the examples. In Example 1, Min(B,C)−100×H²=−0.34, which does not meet Min(B,C)−100×H²≥−0.2 in Formula 1, the thickness expansion rate of the battery in Example 1 is higher, the capacity retention rate is lower, and the capacity recovery rate is lower. In Examples 1-1 to 1-6, the width B of the top sealing edge 204, the width C of the side sealing edge 205, and the content H of the first additive meet Formula 1, thereby reducing battery swelling and capacity reduction and improving the performance of the battery.

The electrolyte solution may further include a second additive, and the second additive may include styrene. A percentage of styrene in a total mass of the electrolyte solution may range from 0.1% to 1% (for example, 0.1%, 0.2%, 0.3%, 0.4%, 0.5%, 0.6%, 0.7%, 0.8%, 0.9%, or 1%).

Styrene can react with the aluminum-plastic film, and molecules of styrene gather on a surface of the aluminum-plastic film and a polymerization reaction takes place on the surface of the aluminum-plastic film, thereby enhancing a packaging effect of the aluminum-plastic film, improving cycling performance and storage performance of the battery, and prolonging the service life of the battery.

Examples 1-7 to 1-14 and Comparative Example 2 are further provided. In the examples and the comparative example, the width B of the top sealing edge 204, the width C of the side sealing edge 205, the content H of the first additive, and a content of styrene are specifically shown in Table 3.

TABLE 3

| Sequence | First additive | | Content of | B | C | Min(B, C) − |
|---|---|---|---|---|---|---|
| number | Type | H | styrene | (mm) | (mm) | 100 × H² |
| Example 1-7 | (VI) | 4% | / | 4 | 10 | 3.84 |
| Example 1-8 | (VII) | 12% | / | 4 | 10 | 2.56 |
| Example 1-9 | (VIII) | 4% | 0.5% | 4 | 10 | 3.84 |
| Example 1-10 | (VIII) | 4% | 0.3 | 4 | 10 | 3.84 |
| Example 1-11 | (VIII) | 4% | 0.7 | 4 | 10 | 3.84 |
| Example 1-12 | (VIII) | 4% | 0.1% | 4 | 10 | 3.84 |
| Example 1-13 | (VIII) | 4% | 1% | 4 | 10 | 3.84 |
| Example 1-14 | (VIII) | 4% | / | 4 | 10 | 3.84 |
| Comparative | / | / | 0.5% | 4 | 10 | 4 |
| Example 2 | | | | | | |

Note:
“/” in Table 3 means nonexistence.

Further, performance tests shown above were performed on Examples 1-7 to 1-14 and Comparative Example 2. In addition, the batteries obtained in Examples 1-7 to 1-14 and Comparative Example 2 were charged and discharged for 200 cycles at 25° C. at a rate of 1 C, with a charge/discharge voltage ranging from 3.0 V to 4.2 V. At the same time, a capacity of the 100th cycle was divided by a capacity of the first cycle to obtain a capacity retention rate after 100 cycles at 25° C. The record results are shown in Table 4.

TABLE 4

| | Capacity | Storage at 60° C. | | |
|---|---|---|---|---|
| | retention rate | Thickness | Capacity | Capacity |
| Sequence | after 100 | expansion | retention | recovery |
| number | cycles at 25° C. | rate | rate | rate |
| Example 1-7 | 86.35% | 13.15% | 61.43% | 71.62% |
| Example 1-8 | 70.36% | 20.72% | 54.91% | 65.35% |
| Example 1-9 | 93.47% | 7.34% | 71.46% | 91.33% |
| Example 1-10 | 94.32% | 7.53% | 71.56% | 91.85% |
| Example 1-11 | 93.98% | 7.11% | 71.32% | 91.90% |
| Example 1-12 | 84.14% | 14.31% | 60.92% | 70.52% |
| Example 1-13 | 85.72% | 16.78% | 60.59% | 75.00% |
| Example 1-14 | 83.31% | 17.93% | 59.41% | 69.13% |
| Comparative | 56.32% | 41.25% | 26.33% | 31.73% |
| Example 2 | | | | |

It may be learned that in this implementation, adding styrene to the electrolyte solution can improve cycling performance and storage performance of the battery.

Preferably, data optimization may be performed based on Formula 1 to obtain Formula 2 below:

$$Min ( B , C ) - 100 \times {H}^{2} \geq 3. \qquad ( Formula 2 )$$

When the width B of the top sealing edge 204, the width C of the side sealing edge 205, and the content H of the first additive meet Formula 2, the performance of the battery may be further improved.

The width B of the top sealing edge 204, the width C of the side sealing edge 205, and a thickness M of the top sealing edge 204 or the side sealing edge 205 meet Formula 3 below:

$$B = \frac{( {x}_{1} + {x}_{2} \times M ) \times C}{{x}_{3} - {x}_{4} \times M + C} , \qquad ( Formula 3 )$$

where x₁, x₂, x₃, and x₄ can all be constants, and the thickness of the top sealing edge 204 or the side sealing edge 205 may be M, in a unit of μm.

It should be understood that values of x₁, x₂, x₃, and x₄ are not limited herein. For example, in some embodiments, x₁ may range from 0.001 to 0.01, and further, x₁ may range from 0.005 to 0.01. In some other embodiments, x₂ may range from 0.001 to 0.01, and further, x₂ may range from 0.001 to 0.005. In some other embodiments, x₃ may range from 0.001 to 0.01, and further, x₃ may range from 0.005 to 0.01. In some other embodiments, x₄ may range from 0.01 to 0.1, and further, x₄ may range from 0.01 to 0.05.

In some embodiments, a value of x₁ may be 0.0092721, a value of x₂ may be 0.0039685, a value of x₃ may be 0.0062564, and a value of x₄ may be 0.0194843. Then, Formula 3 may be expressed as:

$$B = \frac{( 0.0092721 + 0.0039685 \times M ) \times C}{0.0062564 - 0.0194843 \times M + C} .$$

In this way, the sealing edge of the aluminum-plastic film 20 is designed, so that the width B of the top sealing edge 204, the width C of the side sealing edge 205, and the thickness M of the top sealing edge 204 or the side sealing edge 205 meet the foregoing relationship of Formula 3, so as to reduce a content of water vapor entering the interior of the battery through the aluminum-plastic film 20, thereby reducing cases in which water vapor and the —O—SO₂— group react to generate sulfuric acid, and improving the performance of the battery.

Optionally, a strength L of the sealing edge and a content H of the first additive meet Formula 4 below:

$$L - 100 \times H \geq 20. \qquad ( Formula 4 )$$

The strength of the sealing edge may be L, in a unit of N/mm, and represents a heat sealing strength of the sealing edge of the aluminum-plastic film. The content of the first additive may be H, that is, a percentage of the first additive in a total mass of the electrolyte solution, and H≤10%.

The strength of the sealing edge includes a strength of the top sealing edge 204 and a strength of the side sealing edge 205, where L is a smaller strength between the strength of the top sealing edge 204 and the strength of the side sealing edge 205. For example, when the strength of the top sealing edge 204 is less than the strength of the side sealing edge 205, L is the strength of the top sealing edge 204. Otherwise, L is the strength of the side sealing edge 205.

In the present disclosure, the strength L of the sealing edge refers to a tensile force required per unit width to separate two aluminum-plastic films bonded together by hot pressing.

In the present disclosure, the strength L of the sealing edge may be obtained by the following method. Specifically, the two aluminum-plastic films are bonded together by hot pressing and cut into rectangles with a unit width in a sealing direction, and then a tensile machine is used to test a tensile force required to separate the two aluminum-plastic films bonded together.

In this implementation, Example 2 and Examples 2-1 to 2-4 can be provided. In the examples, the width B of the top sealing edge 204, the strength L of the sealing edge, and the content H of the first additive are specifically shown in Table 5.

TABLE 5

| Sequence | First additive | | B | L | L − |
|---|---|---|---|---|---|
| number | Type | H | (mm) | (N/mm) | 100 × H |
| Example 2 | (I) | 8% | 0.3 | 20.686 | 12.686 |
| Example 2-1 | (II) | 4% | 1 | 30.57 | 26.57 |
| Example 2-2 | (III) | 4% | 4 | 72.93 | 68.93 |
| Example 2-3 | (IV) | 1% | 4 | 72.93 | 71.93 |
| Example 2-4 | (V) | 7% | 4 | 72.93 | 65.93 |

Performance tests were separately performed on Example 2 and Examples 2-1 to 2-4. The batteries obtained in the examples were charged and discharged five times at a charge-discharge rate of 1 C at room temperature, and then charged to 4.2 V at a rate of 1 C (with a cut-off current of 0.02 C). A 1 C capacity Q and a battery thickness T were recorded. After the fully charged battery was stored at 60° C. for 30 days, a battery thickness T0 and a 1 C discharge capacity Q1 were recorded. The battery was then charged and discharged at a rate of 1 C at room temperature for five cycles, and a 1 C discharge capacity Q2 was recorded. Experimental data such as a capacity retention rate, a capacity recovery rate, and a thickness expansion rate of the battery stored at a high temperature (60° C.) were obtained through calculation. The record results are shown in Table 6.

TABLE 6

| | Storage at 60° C. | | |
|---|---|---|---|
| | Thickness | Capacity | Capacity |
| Sequence | expansion | retention | recovery |
| number | rate | rate | rate |
| Example 2 | 27.82% | 34.71% | 40.36% |
| Example 2-1 | 18.94% | 55.36% | 59.98% |
| Example 2-2 | 15.85% | 67.54% | 68.65% |
| Example 2-3 | 13.43% | 66.48% | 70.85% |
| Example 2-4 | 13.26% | 65.39% | 71.63% |

It may be learned from Table 5 and Table 6 that in Example 2, L−100×H=12.686, which does not meet L−100×H≥20 in Formula 4, the thickness expansion rate of the battery is higher, the capacity retention rate is lower, and the capacity recovery rate is lower in Example 2. In Examples 2-1 to 2-4, the width B of the top sealing edge 204, the strength L of the sealing edge, and the content H of the first additive meet Formula 4, thereby reducing battery swelling and capacity reduction and improving the performance of the battery.

Styrene was added to the electrolyte solution, and a percentage of styrene in a total mass of the electrolyte solution might range from 0.1% to 1%. Examples 2-5 to 2-7 and Comparative Examples 3 and 4 are further provided. In the examples and comparative examples, details are shown in Table 7.

TABLE 7

| Sequence | First additive | | Content of | B | L | L − |
|---|---|---|---|---|---|---|
| number | Type | H | styrene | (mm) | (N/mm) | 100 × H |
| Example 2-5 | (VI) | 4% | / | 4 | 72.93 | 68.93 |
| Example 2-6 | (VII) | 12% | / | 4 | 72.93 | 60.93 |
| Example 2-7 | (VIII) | 4% | 0.5% | 4 | 72.93 | 68.93 |
| Comparative | / | 0 | 0.5% | 4 | 72.93 | 72.93 |
| Example 3 | | | | | | |
| Comparative | / | 0 | / | 4 | 72.93 | 72.93 |
| Example 4 | | | | | | |

Note:
“/” in Table 7 means nonexistence.

Further, performance tests shown above were performed on Examples 2-5 to 2-7 and Comparative Examples 3 and 4. In addition, the batteries obtained in Examples 2-5 to 2-7 and Comparative Examples 3 and 4 were charged and discharged for 200 cycles at 25° C. at a rate of 1 C, with a charge/discharge voltage ranging from 3.0 V to 4.2 V. At the same time, a capacity of the 100th cycle was divided by a capacity of the first cycle to obtain a capacity retention rate after 100 cycles at 25° C. The record results are shown in Table 8.

TABLE 8

| | Capacity | Storage at 60° C. | | |
|---|---|---|---|---|
| | retention rate | Thickness | Capacity | Capacity |
| Sequence | after 100 cycles | expansion | retention | recovery |
| number | at 25° C. | rate | rate | rate |
| Example 2-5 | 85.67% | 14.09% | 62.18% | 71.84% |
| Example 2-6 | 72.75% | 19.86% | 55.35% | 65.62% |
| Example 2-7 | 94.06% | 6.84% | 70.68% | 91.87% |
| Comparative | 62.34% | 25.63% | 41.57% | 58.51% |
| Example 3 | | | | |
| Comparative | 51.11% | 43.78% | 22.73% | 33.62% |
| Example 4 | | | | |

It may be learned that in this implementation, adding styrene to the electrolyte solution can improve cycling performance and storage performance of the battery. This is because styrene can gather on a surface of the aluminum-plastic film and a polymerization reaction takes place on the surface of the aluminum-plastic film, thereby enhancing a packaging effect of the aluminum-plastic film. In addition, polymer generated by the polymerization reaction of styrene on the surface of the aluminum-plastic film can effectively inhibit sulfuric acid generated by the excessive first additive. The addition of styrene can produce an unexpected synergistic effect, thereby improving the cycling performance and storage performance of the battery, and prolonging the service life of the battery.

Preferably, data optimization may be performed based on Formula 4 to obtain Formula 5 below:

$$L - 100 \times H \geq 30. \qquad ( Formula 5 )$$

When the strength L of the sealing edge and the content H of the first additive meet Formula 5, the performance of the battery may be further improved.

Optionally, the battery further includes a tab, the tab is connected to the jelly roll, and a tab adhesive is disposed on the tab.

Optionally, a tab 101 may be disposed on the jelly roll 10, and a structure of the tab 101 may be a structure of same side tabs shown in FIG. 1, or the structure of the tab 101 may be a structure of counter side tabs shown in FIG. 2. The tab 101 is connected to the jelly roll 10, and a tab adhesive 102 is disposed on the tab 101.

A width O of the tab adhesive 102, a thickness P of the tab adhesive 102, and a content H of the first additive meet Formula 6 below:

$$H \times 100 + \frac{( O + P ) / 2}{10} < 14. \qquad ( Formula 6 )$$

The width of the tab adhesive 102 may be O, in a unit of mm, the thickness of the tab adhesive 102 may be P, in a unit of μm, the content of the first additive may be H, that is, a percentage of the first additive in a total mass of the electrolyte solution, and H≤10%.

In the present disclosure, the width of the tab adhesive 102 refers to a size of the tab adhesive 102 in a width direction of the tab 101.

The width W of the tab 101 and the width O of the tab adhesive 102 meet Formula 7 below:

$$W \leq O - 0.5 . \qquad ( Formula 7 )$$

The width of the tab 101 may be W, in a unit of mm.

The width O of the tab adhesive 102 is greater than the width W of the tab 101 to provide insulation protection. The width O of the tab adhesive 102 may range from 2 millimeters to 70 millimeters, and the thickness P of the tab adhesive 102 may range from 30 micrometers to 250 micrometers.

In this implementation, Example 3 and Examples 3-1 to 3-4 can be provided. In the examples, the width W of the tab 101, the width O of the tab adhesive 102, and the content H of the first additive are specifically shown in Table 9.

TABLE 9

| | First | | | | | | |
|---|---|---|---|---|---|---|---|
| | additive | | | | | | |
| Sequence number | Type | H | W (mm) | P (μm) | O (mm) | $H \times 100 + \frac{( O + P ) / 2}{10}$ | O-W (mm) |
| Example | (I) | 8% | 70 | 70 | 70.5 | 15.025 | 0.5 |
| 3 | | | | | | | |
| Example | (II) | 4% | 50 | 70 | 50.5 | 10.025 | 0.5 |
| 3-1 | | | | | | | |
| Example | (III) | 4% | 20.5 | 70 | 21 | 8.55 | 0.5 |
| 3-2 | | | | | | | |
| Example | (IV) | 1% | 10.5 | 70 | 11 | 5.05 | 0.5 |
| 3-3 | | | | | | | |
| Example | (V) | 7% | 2.5 | 70 | 3 | 10.65 | 0.5 |
| 3-4 | | | | | | | |

Performance tests were separately performed on Example 3 and Examples 3-1 to 3-4. The batteries obtained in the examples were charged and discharged five times at a charge-discharge rate of 1 C at room temperature, and then charged to 4.2 V at a rate of 1 C (with a cut-off current of 0.02 C). A 1 C capacity Q and a battery thickness T were recorded. After the fully charged battery was stored at 60° C. for 30 days, a battery thickness T0 and a 1 C discharge capacity Q1 were recorded. The battery was then charged and discharged at a rate of 1 C at room temperature for five cycles, and a 1 C discharge capacity Q2 was recorded. Experimental data such as a capacity retention rate, a capacity recovery rate, and a thickness expansion rate of the battery stored at a high temperature (60° C.) were obtained through calculation. The record results are shown in Table 10.

TABLE 10

| | Storage at 60° C. | | |
|---|---|---|---|
| | Thickness | Capacity | Capacity |
| | expansion | retention | recovery |
| | rate | rate | rate |
| Example 3 | 25.83% | 38.32% | 43.14% |
| Example 3-1 | 17.98% | 57.24% | 63.15% |
| Example 3-2 | 10.54% | 70.28% | 73.21% |
| Example 3-3 | 10.31% | 68.42% | 74.57% |
| Example 3-4 | 11.58% | 67.84% | 73.89% |

It may be learned from Table 9 and Table 10 that in Example

$$H \times 100 + \frac{( O + P ) / 2}{10} = 15.052 ,$$

which does not meet

$$H \times 100 + \frac{( O + P ) / 2}{10} < 14$$

in Formula 6, the thickness expansion rate is higher, the capacity retention rate is lower, and the capacity recovery rate is lower in Example 3. In Examples 3-1 to 3-4, the width W of the tab 101, the width O of the tab adhesive 102, and the content H of the first additive meet Formula 6 and Formula 7, thereby reducing battery swelling and capacity reduction and improving the performance of the battery.

Styrene was added to the electrolyte solution, and a percentage of styrene in a total mass of the electrolyte solution might range from 0.1% to 1%. Examples 3-5 to 3-7 and Comparative Examples 5 and 6 are further provided. In the examples, details are shown in Table 11.

TABLE 11

| | First additive | | Content | | | | | |
|---|---|---|---|---|---|---|---|---|
| Sequence number | Type | H | of styrene | W (mm) | O (mm) | P (μm) | $H \times 100 + \frac{( O + P ) / 2}{10}$ | O-W (mm) |
| Example 3-5 | (VI) | 4% | / | 2 | 2.5 | 70 | 7.625 | 0.5 |
| Example 3-6 | (VII) | 12% | / | 2 | 2.5 | 70 | 15.625 | 0.5 |
| Example 3-7 | (VIII) | 4% | 0.5% | 2 | 2.5 | 70 | 7.625 | 0.5 |
| Example 3-8 | (VI) | 4% | / | 2 | 2 | 70 | 7.6 | 0 |
| Example 3-9 | (VI) | 4% | / | 2.5 | 2 | 70 | 7.6 | −0.5 |
| Comparative | / | 0 | 0.5% | 2 | 2.5 | 70 | 3.625 | 0.5 |
| Example 5 | | | | | | | | |
| Comparative | / | 0 | / | 2 | 2.5 | 70 | 3.625 | 0.5 |
| Example 6 | | | | | | | | |

Note:
“/” in Table 11 means nonexistence.

Further, performance tests shown above were performed on Examples 3-5 to 3-9 and Comparative Examples 5 and 6. In addition, the batteries obtained in Examples 3-5 to 3-9 and Comparative Examples 5 and 6 were charged and discharged for 200 cycles at 25° C. at a rate of 1 C, with a charge/discharge voltage ranging from 3.0 V to 4.2 V. At the same time, a capacity of the 100th cycle was divided by a capacity of the first cycle to obtain a capacity retention rate after 100 cycles at 25° C. The record results are shown in Table 12.

TABLE 12

| | Capacity | Storage at 60° C. | | |
|---|---|---|---|---|
| | retention rate | Thickness | Capacity | Capacity |
| | after 100 cycles | expansion | retention | recovery |
| | at 25° C. | rate | rate | rate |
| Example 3-5 | 85.96% | 13.59% | 60.56% | 70.95% |
| Example 3-6 | 69.93% | 20.06% | 55.69% | 66.25% |
| Example 3-7 | 94.56% | 7.68% | 70.48% | 90.87% |
| Example 3-8 | 62.34% | 21.55% | 53.16% | 54.44% |
| Example 3-9 | 61.16% | 23.12% | 51.31% | 51.61% |
| Comparative | 58.34% | 38.01% | 29.73% | 39.90% |
| Example 5 | | | | |
| Comparative | 50.04% | 40.85% | 21.73% | 31.20% |
| Example 6 | | | | |

It may be learned that in this implementation, adding styrene to the electrolyte solution can improve cycling performance and storage performance of the battery.

Preferably, data optimization may be performed based on Formula 6 and Formula 7 to obtain Formula 8 below:

$$H \times 100 + \frac{( O + P ) / 2}{10} < 12. \qquad ( Formula 8 )$$

When the width O of the tab adhesive 102, the thickness P of the tab adhesive 102, and the content H of the first additive meet Formula 8, the performance of the battery may be further improved.

Further preferably, data optimization may be performed based on Formula 6, Formula 7, and Formula 8 to obtain Formula 9 below:

$$H \times 100 + \frac{( O + P ) / 2}{10} < 10. \qquad ( Formula 9 )$$

When the width O of the tab adhesive 102, the thickness P of the tab adhesive 102, and the content H of the first additive meet Formula 9, the performance of the battery may be further improved.

An embodiment of the present disclosure further provides an electronic device. The electronic device includes the foregoing battery.

It should be noted that the implementation of the foregoing battery embodiment is also applicable to the embodiment of the electronic device and can achieve the same technical effect, and details are not described herein again.

It should be noted that, as used herein, terms “include”, “contain”, or any other variants thereof are intended to cover non-exclusive inclusion so that a process, method, article, or apparatus that includes a series of elements not only includes these very elements, but may also include other elements not expressly listed, or also include elements inherent to this process, method, article, or apparatus. Without being subject to further limitations, an element defined by a phrase “including . . . ” does not exclude presence of other identical elements in the process, method, article, or apparatus that includes the element. In addition, it should be noted that the scope of the methods and apparatuses in the implementations of the present disclosure is not limited to performing functions in the order discussed, but may also include performing functions in a substantially simultaneous manner or in a reverse order based on the functions involved. For example, the described methods may be performed in an order different from that described, and various steps may be added, omitted, or combined. In addition, features described with reference to some examples may be combined in other examples.

The embodiments of the present disclosure are described above with reference to the accompanying drawings, but the present disclosure is not limited to the foregoing specific implementations. The foregoing specific implementations are merely illustrative and nonrestrictive. Under the guidance of the present disclosure, a person of ordinary skill in the art can also make many forms without departing from the scope of protection of the present disclosure and the claims, all of which are within the protection of the present disclosure.

What is claimed is:

1. A battery, comprising a jelly roll, an electrolyte solution, and an aluminum-plastic film, wherein the aluminum-plastic film comprises an upper film and a lower film disposed opposite to each other, the upper film and the lower film cooperate to form an accommodating cavity, the jelly roll and the electrolyte solution are disposed in the accommodating cavity, a sealing edge is formed at a position at which the upper film and the lower film are connected, the sealing edge is configured to seal the accommodating cavity, the electrolyte solution comprises a first additive, and the first additive comprises a compound containing an —O—SO₂— group.

2. The battery according to claim 1, wherein the first additive comprises at least one of compounds represented by Formula (I) to Formula (XXIV):

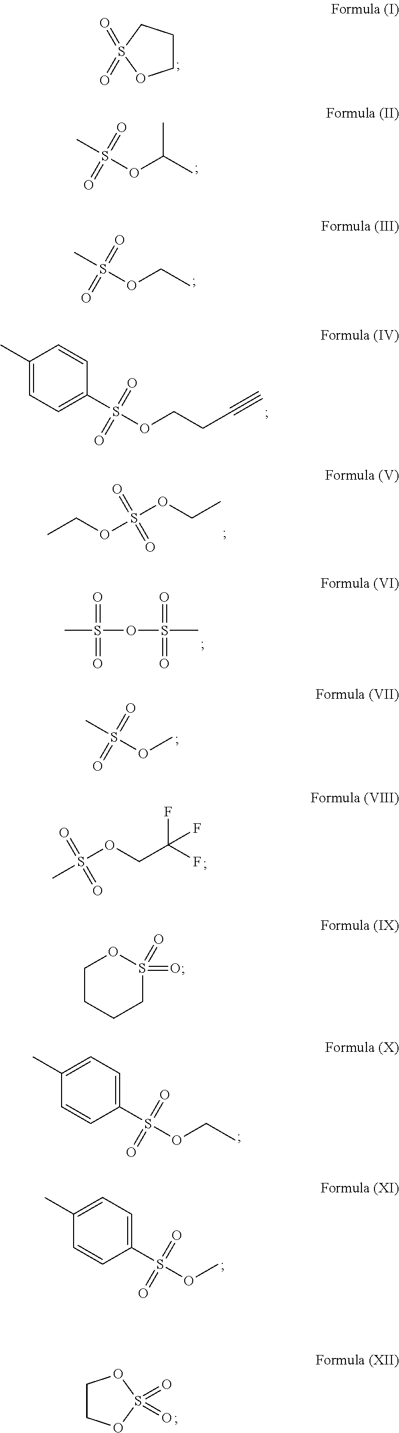

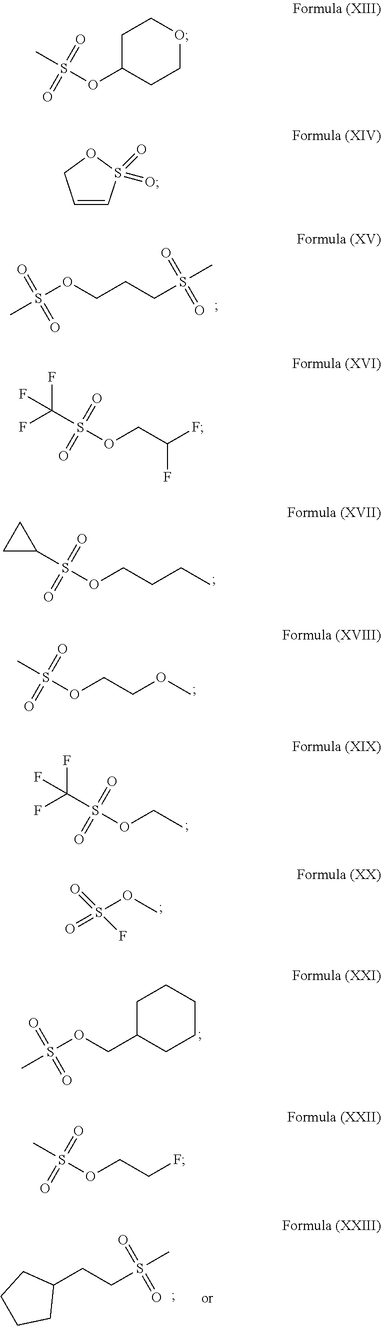

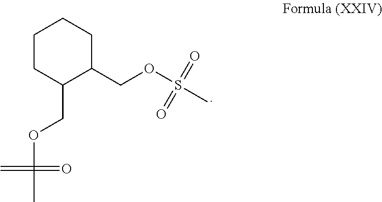

3. The battery according to claim 2, wherein the first additive comprises at least one of compounds represented by Formula (I) to Formula (VIII):

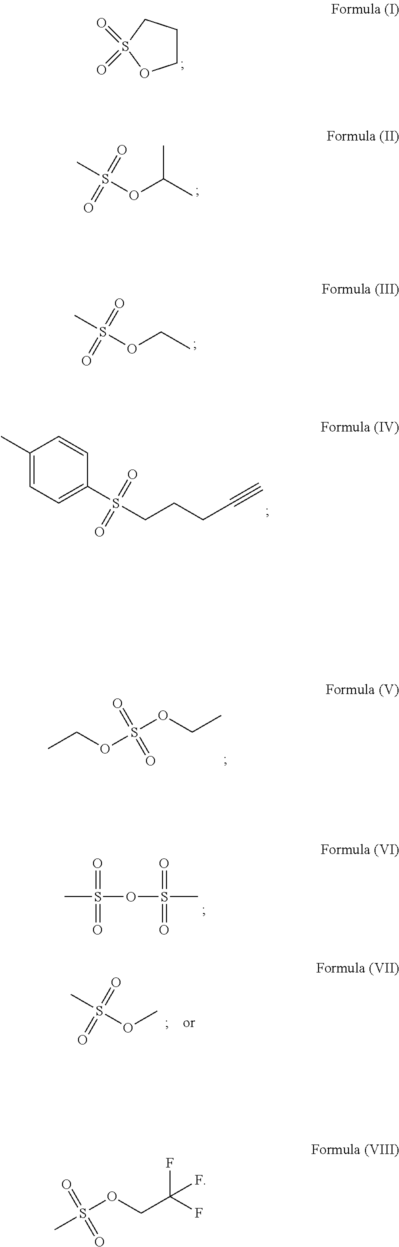

4. The battery according to claim 1, wherein the sealing edge comprises a top sealing edge and a side sealing edge, and a width B of the top sealing edge, a width C of the side sealing edge, and a content H of the first additive meet Formula 1:
$$Min ( B , C ) - 100 \times {H}^{2} \geq - 0.2 . \qquad ( Formula 1 )$$

5. The battery according to claim 4, wherein the content H of the first additive is less than or equal to 10%.

6. The battery according to claim 4, wherein the width B of the top sealing edge, the width C of the side sealing edge, and the content H of the first additive meet Formula 2:
$$Min ( B , C ) - 100 \times {H}^{2} \geq 3 . \qquad ( Formula 2 )$$

7. The battery according to claim 4, wherein the width B of the top sealing edge, the width C of the side sealing edge, and a thickness M of the top sealing edge or the side sealing edge meet Formula 3:
$$B = \frac{( {x}_{1} + {x}_{2} \times M ) \times C}{{x}_{3} - {x}_{4} \times M + C} , \qquad ( Formula 3 )$$
wherein x₁, x₂, x₃, and x₄ are all constants.

8. The battery according to claim 7, wherein the width B of the top sealing edge, the width C of the side sealing edge, and the thickness M of the top sealing edge or the side sealing edge meet Formula 3-1:
$$B = \frac{( 0.0092721 + 0.0039685 \times M ) \times C}{0.0062564 - 0.0194843 \times M + C} . \qquad ( Formula 3 - 1 )$$

9. The battery according to claim 1, wherein a strength L of the sealing edge and a content H of the first additive meet Formula 4:
$$L - 100 \times H \geq 20 . \qquad ( Formula 4 )$$

10. The battery according to claim 9, wherein the content H of the first additive is less than or equal to 10%.

11. The battery according to claim 9, wherein the strength L of the sealing edge and the content H of the first additive meet Formula 5:
$$L - 100 \times H \geq 30 . \qquad ( Formula 5 )$$

12. The battery according to claim 1, wherein the battery further comprises a tab, the tab is connected to the jelly roll, and a tab adhesive is disposed on the tab, wherein
a width O of the tab adhesive, a thickness P of the tab adhesive, and a content H of the first additive meet Formula 6:
$$H \times 100 + \frac{( O + P ) / 2}{10} < 14 ; \qquad ( Formula 6 )$$
and
a width direction of the tab adhesive is the same as a width direction of the tab.

13. The battery according to claim 12, wherein the content H of the first additive is less than or equal to 10%.

14. The battery according to claim 12, wherein the width O of the tab adhesive, the thickness P of the tab adhesive, and the content H of the first additive meet Formula 8:
$$H \times 100 + \frac{( O + P ) / 2}{10} < 12. \qquad ( Formula 8 )$$

15. The battery according to claim 13, wherein a width W of the tab and the width O of the tab adhesive meet Formula 7:
$$W \leq O - 0.5 . \qquad ( Formula 7 )$$

16. The battery according to claim 14, wherein a width W of the tab and the width O of the tab adhesive meet Formula 7:
$$W \leq O - 0.5 . \qquad ( Formula 7 )$$

17. The battery according to claim 14, wherein the width O of the tab adhesive, the thickness P of the tab adhesive, and the content H of the first additive meet Formula 9:
$$H \times 100 + \frac{( O + P ) / 2}{10} < 10. \qquad ( Formula 9 )$$

18. The battery according to claim 1, wherein the electrolyte solution further comprises a second additive, and the second additive comprises styrene.

19. The battery according to claim 18, wherein a percentage of styrene in a total mass of the electrolyte solution ranges from 0.1% to 1%.

20. An electronic device, wherein the electronic device comprises the battery according to claim 1.
